(19) United States
(12) Patent Application Publication
(10) Pub. No.: US 2012/0331227 A1
(43) Pub. Date: Dec. 27, 2012

(54) FACILITATING IMPLEMENTATION, AT LEAST IN PART, OF AT LEAST ONE CACHE MANAGEMENT POLICY

(76) Inventor: Ramakrishna Saripalli, Cornelius, OR (US)

(21) Appl. No.: 13/165,606

(22) Filed: Jun. 21, 2011

(51) Int. Cl. G06F 12/08

(52) U.S. Cl. 711/118; 711/E12.017

(57) ABSTRACT

An embodiment may include circuitry to facilitate implementation, at least in part, of at least one cache management policy. The at least one policy may be based, at least in part, upon respective priorities of respective classifications of respective network traffic. The at least one policy may concern, at least in part, caching of respective information associated, at least in part, with the respective network traffic belonging to the respective classifications. Many alternatives, variations, and modifications are possible.

### FIELD

This disclosure relates to facilitating implementation, at least in part, of at least one cache management policy.

### BACKGROUND

In one conventional computing arrangement, a network includes two end nodes that are communicatively coupled via an intermediate node. The codes include converged network adapters that employ data center bridging protocols to control and prioritize different types and/or flows of network traffic among the nodes. An adapter in a given node may be capable of caching, in accordance with a cache management policy, address translations (e.g., virtual to physical) for buffers posted for processing of the network traffic. The adapter may utilize these translations to access the buffers and process the traffic associated with the buffers.

In this conventional arrangement, the network traffic control and/or prioritization policies reflected in and/or implemented by the data center bridging protocols are not reflected in and/or implemented by the cache management policy. This may result in cache misses occurring relatively more frequently for translations associated with higher priority traffic than for lower priority traffic. This may result in increased latency in processing the higher priority traffic. This latency may become more pronounced and/or worsen over time, and/or be reflected in related network traffic congestion. These phenomena may undermine and/or defeat the network traffic control and/or prioritization policies that were intended to be implemented in the network.

### BRIEF DESCRIPTION OF THE SEVERAL VIEWS OF THE DRAWINGS

Features and advantages of embodiments will become apparent as the following Detailed Description proceeds, and upon reference to the Drawings, wherein like numerals depict like parts, and in which:

FIG. 1 illustrates a system embodiment.

FIG. 2 illustrates features in an embodiment.

FIG. 3 illustrates features in an embodiment.

Although the following Detailed Description will proceed with reference being Made to illustrative embodiments, many alternatives, modifications, and variations thereof will be apparent to those skilled in the art. Accordingly, it is intended that the claimed subject matter be viewed broadly.

### DETAILED DESCRIPTION

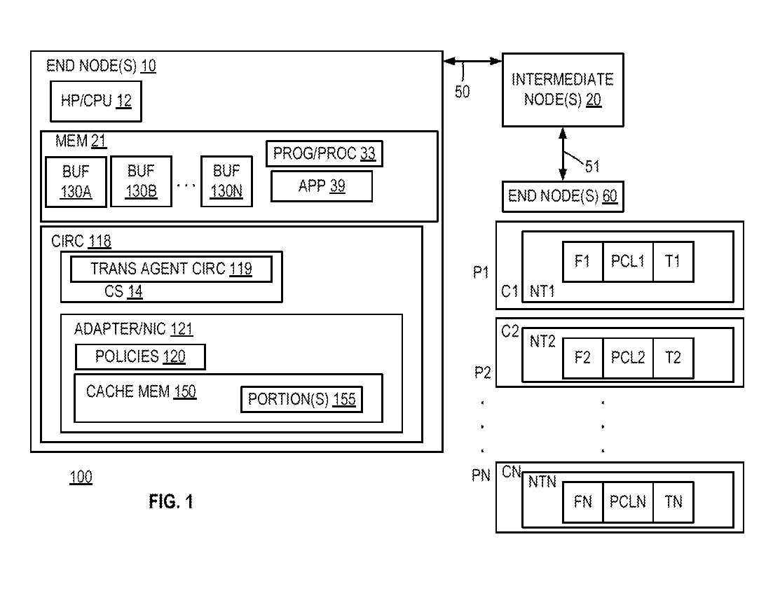

FIG. 1 illustrates a system embodiment 100. System 100 may include one or more end nodes 10 that may be communicatively coupled, via network 50, to one or more intermediate nodes 20. System 100 also may comprise one or more intermediate nodes 20 may be communicatively coupled, via network 51, to one or more end nodes 60. This may permit one or more end nodes 10 to be communicatively coupled, via network 50, one or more intermediate nodes 20, and network 51, to one or more end nodes 60.

In this embodiment, one or more end nodes 10, intermediate nodes 20, and/or end nodes 60 may be geographically remote from each other. In an embodiment, the terms “host computer,” “host,” “server,” “client,” “network node,” “end station,” “end node,” “intermediate node,” “intermediate station,” and “node” may be used interchangeably, and may mean, for example, without limitation, one or more end stations, mobile interne devices, smart phones, media (e.g., audio and/or video) devices, input/output (I/O) devices, tablet computers, appliances, intermediate stations, network interfaces, clients, servers, and/or portions thereof. In this embodiment, a “bridge,” “switch,” and “intermediate node” may be used interchangeably, and may comprise one or more nodes that are capable, at least in part, of receiving, at least in part, one or more packets from one or more senders, and transmitting, at least in part, the one or more packets to one or more receivers.

In this embodiment, a “network” may be or comprise any mechanism, instrumentality, modality, and/or portion thereof that may permit, facilitate, and/or allow, at least in part, two or more entities to be communicatively coupled together. Also in this embodiment, a first entity may be “communicatively coupled” to a second entity if the first entity is capable of transmitting to and/or receiving from the second entity one or more commands and/or data. In this embodiment, a “wireless network” may mean a network that permits, at least in part, at least two entities to be wirelessly communicatively coupled, at least in part. In this embodiment, a “wired network” may mean a network that permits, at least in part, at least two entities to be communicatively coupled, at least in part, non-wirelessly. In this embodiment, data and information may be used interchangeably, and may be or comprise one or more commands (for example one or more program instructions), and/or one or more such commands may be or comprise data and/or information. Also in this embodiment, an “instruction” may include data and/or one or more commands. Although each of the nodes 10, 20, and/or 60, and/or each of the networks 50 and/or 51 may be referred to in the singular, it should be understood that each such respective component may comprise a plurality of such respective components without departing from this embodiment.

In this embodiment, one or more end nodes 60, one or more intermediate nodes 20, and/or one or more end nodes 10 may be, constitute, or comprise one or more respective network hops from and/or to which one or more packets may be propagated. In this embodiment, a hop or network hop may be or comprise one or more nodes in a network to and/or from which one or more packets may be transmitted (e.g., in furtherance of reaching and/or to reach an intended destination). In this embodiment, a packet may be or comprise one or more symbols and/or values.

End node 10 may comprise one or more single and/or multi-core host processors (HP)/central processing units (CPU) 12, computer-readable/writable memory 21, and circuitry 118. Circuitry 118 may include one or more chipsets (CS) 14 and/or network adapter/network interface controller (NIC) 121. In this embodiment, although not shown in the Figures, HP 12, memory 21, and/or CS 14 may be comprised, at least in part, in one or more system motherboards. Also although not shown in the Figures, network adapter 121 may be comprised, at least in part, in one or more circuit boards. The one or more not shown system motherboards may be physically and communicatively coupled to the one or more not shown circuit boards via a not shown bus connector/slot system.

One or more chipsets 14 may comprise, e.g., memory, input/output controller circuitry, and/or network interface controller circuitry. One or more host processors 12 may be communicatively coupled via the one or more chipsets 14 to memory 21 and/or adapter 121.

Alternatively or additionally, although not shown in the Figures, some or all of circuitry 118 and/or the functionality and components thereof may be comprised in, for example, in one or more host processors 12 and/or one or more programs/processes 33 that may be executed, at least in part, by one or more host processors 12. When so executed, at least in part, by one or more host processors 12, one or more processes 33 may become resident, at least in part, in memory 21, and may result in one or more host processors 12 executing identical, similar, and/or analogous operations to at least a subset of the operations described herein as being performed by circuitry 118. Also alternatively, one or more host processors 12, memory 21, the one or more chipsets 14, and/or some or all of the functionality and/or components thereof may be comprised in, for example, circuitry 118 and/or the one or more not shown circuit boards. Also alternatively, some or all of the functionality and/or components of one or more chipsets 14 may be comprised in adapter 121, or vice versa. Further alternatively, at least certain of the contents of memory 21 may be stored in circuitry 118 and/or adapter 121, or vice versa. Many other alternatives are possible without departing from this embodiment.

One or more nodes 20 and/or 60 each may comprise respective components that may be identical or substantially similar, at least in part, in their respective constructions, operations, and/or capabilities to the respective construction, operation, and/or capabilities of the above described (and/other other) components of one or more nodes 10. Of course, alternatively, without departing from this embodiment, the respective constructions, operations, and/or capabilities of one or more nodes 20 and/or 60 (and/or one or more components thereof) may differ, at least in part, from the respective construction, operation, and/or capabilities of one or more nodes 10 (and/or one or more components thereof).

In this embodiment, “circuitry” may comprise, for example, singly or in any combination, analog circuitry, digital circuitry, hardwired circuitry, programmable circuitry, co-processor circuitry, processor circuitry, controller circuitry, state machine circuitry, and/or memory that may comprise program instructions that may be executed by programmable circuitry. Also in this embodiment, a host processor, processor, processor core, core, and/or controller each may comprise respective circuitry capable of performing, at least in part, one or more arithmetic and/or logical operations, such as, for example, one or more respective central processing units. Also in this embodiment, a chipset and an adapter each may comprise respective circuitry capable of communicatively coupling, at least in part, two or more of the following: one or more host processors, storage, mass storage, one or more nodes, and/or memory. Although not shown in the Figures, each of the nodes 10, 20, and/or 60 may comprise a respective graphical user interface system. The not shown graphical user interface systems each may comprise, e.g., a respective keyboard, pointing device, and display system that may permit a human user to input commands to, and monitor the operation of, one or more nodes 10, 20, 60, and/or system 100.

Memory 21 may comprise one or more of the following types of memories: semiconductor firmware memory, programmable memory, non-volatile memory, read only memory, electrically programmable memory, random access memory, flash memory, magnetic disk memory, optical disk memory, and/or other or later-developed computer-readable and/or writable memory. One or more machine-readable program instructions may be stored in memory 21, one or more chipsets 14, adapter 121, and/or circuitry 118. In operation, these instructions may be accessed and executed by one or more host processors 12, circuitry 118, one or more chipsets 14, adapter 121, and/or circuitry 118. When so accessed executed, these one or more instructions may result in one or more these components of system 100, performing operations described herein as being performed by these components of system 100.

In this embodiment, a portion, subset, or fragment of an entity may comprise all of, more than, or less than the entity. Additionally, in this embodiment, a value may be “predetermined” if the value, at least in part, and/or one or more algorithms, operations, and/or processes involved, at least in part, in generating and/or producing the value is predetermined, at least in part. Also, in this embodiment, a process, thread, daemon, program, driver, operating system, application, and/or kernel each may (1) comprise, at least in part, and/or (2) result, at least in part, in and/or from, execution of one or more operations and/or program instructions. In this embodiment, a buffer may comprise one or more locations (e.g., specified and/or indicated, at least in part, by one or more addresses) in memory iu which data and/or one or more commands may be stored, at least temporarily.

Although not shown in the Figures, node 10 may comprise one or more virtual machine monitor (VMM) processes that may be executed, at least in part, by one or more host processors 12. The one or more VMM processes may permit virtualized environments (e.g., comprising one or more virtual machines and/or I/O virtualization) to be implemented in and/or by node 10.

In this embodiment, nodes 10 and 20 may exchange data and/or commands via network 50 in accordance with one or more protocols. Similarly, nodes 20 and 60 may exchange data and/or commands via network 51 in accordance with such protocols. For example, in this embodiment, these one or more protocols may be compatible with, e.g., one or more Ethernet and/or Transmission Control Protocol/Internet Protocol (TCP/IP) protocols.

For example, one or more Ethernet protocols that may be utilized in system 100 may comply or be compatible with Institute of Electrical and Electronics Engineers, Inc. (IEEE) Std. 802.3-2008, Dec. 26, 2008 (including, for example, Annex 31B entitled “MAC Control Pause Operation”); IEEE Std. 802.1Q-2005, May 19, 2006; IEEE Draft Standard P802.1Qau/D2.5, Dec. 18, 2009; IEEE Draft Standard P802.1Qaz/D1.2, Mar. 1, 2010; and/or, IEEE Draft Standard P802.1Qbb/D1.3, Feb. 10, 2010. The TCP/IP protocol that may be utilized in system 100 may comply or be compatible with the protocols described in Internet Engineering Task Force (IETF) Request For Comments (RFC) 791 and 793, published September 1981. Additionally or alternatively, such exchange of data and/or conunands may be in accordance and/or compatible with one or more iSCSI and/or Fibre Channel Over Ethernet protocols. For example, the one or more iSCSI protocols may comply or be compatible with the protocols described in IETF RFC 3720, published April 2004. Also, for example, the one or more Fibre Channel Over Ethernet protocols may comply or be compatible with the protocols described in FIBRE CHANNEL BACKBONE-5 (FC-BB-5) REV 2.00, InterNational Committee for Information Technology Standards (INCITS) working draft proposed by American National Standard for Information Technology, T11/Project 1871-D/Rev 2.00, Jun. 4, 2009. Many different, additional, and/or other protocols (including, for example, those related to those stated above) may be used for such data and/or command exchange without departing from this embodiment (e.g., earlier and/or later-developed versions of the aforesaid, related, and/or other protocols).

Also in this embodiment, I/O virtualization, transmission, management, and/or translation techniques may be implemented by circuitry 118, chipset 14, and/or adapter 121 that may comply and/or be compatible, at least in part, with one or more Peripheral Component Interconnect (PCI)-Special Interest Group (SIG) protocols. For example, such protocols may comply and/or be compatible, at least in part, with one or more protocols disclosed in PCI-SIG Single Root I/O Virtualization And Sharing Specification, Rev. 1.1, 2010, and/or PCI-SIG Address Translation Services Specification, Rev. 1.0, 2007. Of course, many different, additional, and/or other protocols (including, for example, those stated above) may be implemented in node 10 without departing from this embodiment (e.g., earlier and/or later-developed versions of the aforesaid, related, and/or other protocols).

For example, in this embodiment, node 60 may issue to node 10, via network 51, node 20, and/or network 50, respective network traffic (NT) (e.g., NT1, NT2 . . . NTN). The respective network traffic NT1, NT2 . . . NTN may be, be associated with, comprise, be comprised in, belong to, and/or be classified in respective different classifications C1, C2 . . . CN of network traffic. These respective classifications C1, C2 . . . CN may be assigned to, associated with, comprise, be comprised in, belong to, and/or be of different respective priorities P1, P2 . . . PN. In this embodiment, these respective priorities P1, P2 . . . PN may result, at least in part, in establishment of and/or embody, at least in part, of relative priorities between or among the respective network traffic NT1, NT2 . . . NTN. For example, traffic NT1 that is assigned priority P1 may have a relatively higher priority than traffic NT2 that is assigned priority P2, and traffic NTN that is assigned priority PN may have a relatively lower priority than traffic NT1 and NT2. In this embodiment, network traffic may comprise one or more packets. In this embodiment, a priority assigned to network traffic may imply, indicate, request, and/or be associated with a maximum transmission and/or processing latency and/or congestion that is to be considered acceptable, tolerable and/or permitted for and/or in connection with such traffic. Thus, for example, the assigning of a fust priority to first traffic that is relatively higher than a second priority that is assigned to second traffic may imply that a lower maximum processing latency may be considered acceptable in connection with the first traffic than may be the case in connection with the second traffic.

In this embodiment, the respective classifications C1, C2, . . . CN and/or priorities P1, P2, PN may be based, at least in part, upon respective criteria associated with the respective traffic NT1, NT2, . . . NTN. Such respective criteria may be or comprise, for example, one or more respective traffic flows F1, F2, . . . FN of the respective traffic NT1, NT2, . . . NTN, one or more respect protocols PCL1, PCL2, . . . PCLN of and/or employed by the respective traffic NT1, NT2, NTN and/or respective types T1, T2, . . . TN of the respective traffic NT1, NT2, . . . NTN. In this embodiment, a traffic flow may be associated with and/or indicated by, for example, one or more commonalities between or among multiple packets in given network traffic, such as, one or more respective common addresses (e.g., source and/or destination addresses), one or more respective common ports (e.g., TCP ports), and/or one or more respective common services (I/O, media, storage, etc. services) associated with and/or accessed by multiple packets in the network traffic. Commonalities in the respective protocols employed in, and the respective types of, network traffic may also be characteristic of and/or used to classify the traffic into the respective network traffic NT1 . . . NTN and/or the respective network traffic classifications C1 . . . CN. In this embodiment, the respective classifications and/or respective priorities assigned to the respective network traffic, and/or the respective criteria upon which such respective classifications and/or priorities of the network traffic may be assigned, may be in accordance and/or compatible with, at least in part, the one or more Ethernet and/or TCP/IP protocols described previously. Additionally, the manner in which (1) such classifications and/or priorities may be assigned and/or (2) such congestion determinations may be made and/or communicated in system 100, may be in accordance and/or compatible with, at least in part, these one or more previously described Ethernet and/or TCP/IP protocols.

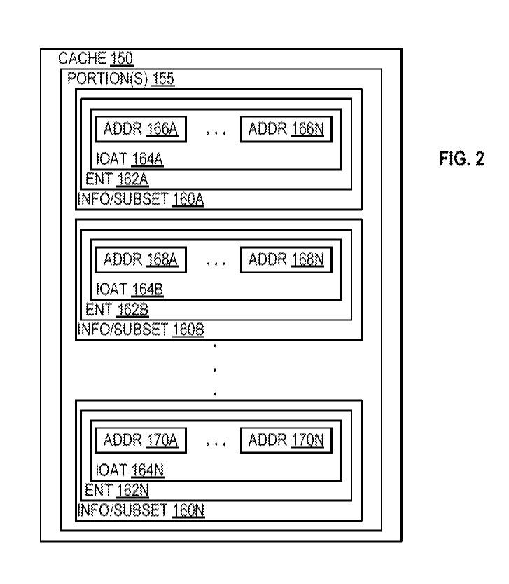

In this embodiment, circuitry 118 may permit and/or facilitate implementation, at least in part, of one or more cache management policies 120. Although shown in FIG. 1 as being stored in adapter 121, these one or more cache management policies 120 may be stored in, at least in part, circuitry 118, adapter 121, one or more chipsets 14, and/or address translation agent circuitry 119 comprised in one or more chipsets 14. These one or more policies 120 may be based, at least in part, the respective priorities P1 . . . PN of the respective classifications C1 . . . CN of the respective network traffic NT1 . . . NTN. These one or more policies 120 may concern, at least in part, caching of respective information and/or subsets of such information 160A . . . 160N (see FIG. 2) that may be associated, at least in part, with the respective network traffic NT1 . . . NTN belonging to the respective classifications C1 . . . CN.

For example, in this embodiment, circuitry 118 may implement, at least in part, address translation services and/or address translation caching that may comply and/or be compatible with, at least in part, PCI-SIG Address Translation Services Specification, Rev. 1.0, 2007 and/or other such address translation services, caching, protocols, and/or mechanisms. In order to facilitate this, adapter 121 may comprise cache memory 150 to store one or more portions 155 of the respective information 160A . . . 160N. The one or more portions of the respective information 160A . . . 160N may be generated and/or provided, at least in part, by address translation agent circuitry 119 to adapter 121 for storage by adapter 121 in cache 150, as a result, at least in part, of address translation and/or other messages exchanged between adapter 121 and chipset 14 and/or agent circuitry 119. In this embodiment, adapter 121 may be capable of retrieving the data stored in cache memory 150 faster than adapter 121 may be capable of retrieving data stored in other memory (e.g., system memory 21) in node 10. Although not shown in the Figures, cache 150 may be comprised, at least in part, in chipset 14 and/or agent circuitry 119. Cache 150 may be, comprise, utilize, and/or implement, at least in part, one or more I/O translation look-aside buffers.

As shown in FIG. 2, one or more portions 155 may comprise respective information 160A . . . 160N. Respective information 160A . . . 160N may comprise one or more respective address translation cache entries 162A . . . 162N. Respective address translation cache entries 162A . . . 162N may comprise respective I/O address translation (IOAT) information 164A . . . 164N. Respective information 164A . . . 164N may be associated, at least in part, with respective buffers 130A . . . 130N in memory 21 that may be associated with, at least in part, respective network traffic NT1 . . . NTN. These buffers 130A . . . 130N may correspond to and/or be associated with, at least in part, one or more intended destinations (at least temporarily) for one or more packets in the network traffic NT1 . . . NTN.

In this embodiment, the respective IOAT information 164A may comprise one or more addresses and/or other information 166A . . . 166N that may permit adapter 121 to translate, at least in part, one or more virtual addresses (e.g., one or more virtual addresses 166A) associated with, specified in, and/or indicated by, at least in part, one or more packets in network traffic NT1 to one or more corresponding physical addresses (e.g., one or more physical addresses 166N) of one or more intended destinations of these one or more packets. For example, one or more virtual addresses 166A may correspond to, at least in part, one or more physical addresses 166N, and these addresses 166A, 166N may correspond to, address, indicate, and/or specify, at least in part, as one or more intended destinations of these one or more packets, one or more buffers 130A. Based at least in part upon this information 164A, adapter 121 may translate, at least in part, one or more virtual addresses 166A associated with traffic NT1 into one or more physical addresses 166N of one or more buffers 130A, and adapter 121 may store, at least in part, the traffic NT1 in the one or more buffers 130A.

Also in this embodiment, the respective IOAT information 164B may comprise one or more addresses and/or other information 168A . . . 168N that may permit adapter 121 to translate, at least in part, one or more virtual addresses (e.g., one or more virtual addresses 168A) associated with, specified in, and/or indicated by, at least in part, one or more packets in network traffic NT2 to one or more corresponding physical addresses (e.g., one or more physical addresses 168N) of one or more intended destinations of these one or more packets. For example, one or more virtual addresses 168A may correspond to, at least in part, one or more physical addresses 168N, and these addresses 168A, 168N may correspond to, address, indicate, and/or specify, at least in part, as one or more intended destinations of these one or more packets, one or more buffers 130B. Based at least in part upon this information 164B, adapter 121 may translate, at least in part, one or more virtual addresses 168A associated with traffic NT2 into one or more physical addresses 168N of one or more buffers 130B, and adapter 121 may store, at least in part, the traffic NT2 in the one or more buffers 130B.

In this embodiment, the respective IOAT information 164N may comprise one or more addresses and/or other information 170A . . . 170N that may permit adapter 121 to translate, at least in part, one or more virtual addresses (e.g., one or more virtual addresses 170A) associated with, specified in, and/or indicated by, at least in part, one or more packets in network traffic NTN to one or more corresponding physical addresses (e.g., one or more physical addresses 170N) of one or more intended destinations of these one or more packets. For example, one or more virtual addresses 170A may correspond to, at least in part, one or more physical addresses 170N, and these addresses 170A, 170N may correspond to, address, indicate, and/or specify, at least in part, as one or more intended destinations of these one or more packets, one or more buffers 130N. Based at least in part upon this information 164N, adapter 121 may translate, at least in part, one or more virtual addresses 170A associated with traffic NTN into one or more physical addresses 170N of one or more buffers 130N, and adapter 121 may store, at least in part, the traffic NTN in the one or more buffers 130N.

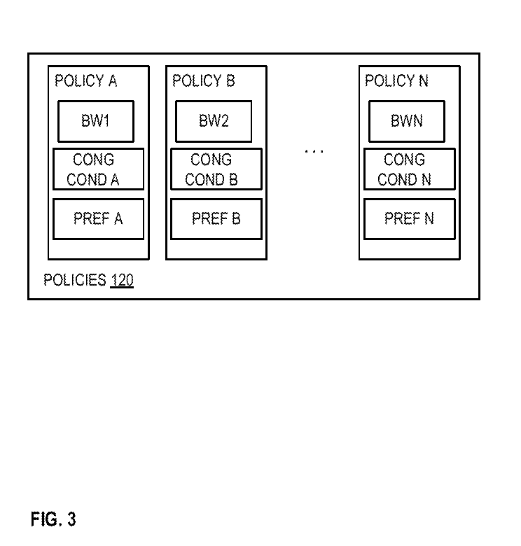

Advantageously, as shown in FIG. 3, in this embodiment, one or more cache management policies 120 may implement, comprise, and/or be based upon, at least in part, (1) respective policies (e.g., POLICY A . . . N) for filling and/or evicting respective cache entries associated with the respective information 160A . . . 160N, (2) respective amounts of I/O translation cache bandwidth BW1 . . . BWN to be allocated to the respective information 160A . . . 160N, and/or (3) one or more preferences (PREF A . . . PREF N) selected, at least in part, by user input and/or one or more applications 39. These one or more respective policies POLICY A . . . N may be based at least in part upon network congestion (e.g., network congestion conditions A . . . N) and/or the respective cache bandwidth amounts BW1 . . . BWN. These respective policies POLICY A . . . N also may be based, at least in part, upon the respective priorities P1 . . . PN and/or relative priorities resulting from priorities P1 . . . PN of respective traffic NT1 . . . NTN.

Advantageously, in this embodiment, by appropriately selecting and/or adjusting the criteria and/or values thereof upon which one or more policies 120 may based, one or more policies 120 may be made to reflect and/or implement the respective priorities P1 . . . PN of and/or the relative priorities established among the network traffic NT1 . . . NTN. Accordingly, and advantageously, one or more policies 120 may result in, at least in part, a relatively lower cache miss probability occurring in connection with respective information (e.g., respective information 160A) associated with relatively higher priority network traffic (e.g., NT1) compared to a relatively higher cache miss probability that may occur in connection with other respective information (e.g., respective information 160N) that may be associated with relatively lower priority network traffic (e.g., NTN).

Also advantageously, in this embodiment, one or more policies 120 may dynamically allocate to and/or fill respective amounts of cache bandwidth BW1 . . . BWN with the respective information 160A . . . 160N based at least in part upon (1) the respective relative priorities of the respective network traffic NT1 . . . NTN, and (2) changes (e.g., real-time and/or historical changes and/or patterns resulting in and/or likely to result in congestion) in the respective network traffic NT1 . . . NTN. Advantageously, the one or more policies 120 may result, at least in part, in a relatively higher cache eviction rate/probability for respective information (e.g., respective information 160N) that is associated with relatively lower priority network traffic (e.g., traffic NTN) compared to a relatively higher cache eviction rate/probability for respective information (e.g., respective information 160A) associated with relatively higher priority network traffic (e.g., traffic NT1). The one or more policies 120 may allocate a relatively larger amount of cache bandwidth (e.g., BW1) to the respective information (e.g., respective information 160A) associated with the relatively higher priority network traffic (e.g., traffic NT1) compared to a relatively smaller amount of cache bandwidth (e.g., BWN) that may be allocated to the respective information (e.g., respective information 160N) associated with the relatively lower priority network traffic (e.g., traffic NTN).

In this embodiment, filling a cache memory may comprise initiating the storing of and/or storing, at least in part, data in the cache memory. In this embodiment, eviction of first data from a cache memory may comprise (1) indicating that the first data may be overwritten with, at least in part, second data, (2) overwriting, at least in part, the first data with the second data, (3) de-staging, at least in part, the first data from the cache memory, and/or (4) deleting, at least in part, the first data from the cache memory. In this embodiment, bandwidth of a cache memory may concern, implicate, and/or relate to, at least in part, for example, one or more data processing, storage, and/or transfer capabilities, uses, rates, and/or characteristics of the cache memory. In this embodiment, a cache management policy may comprise, implicate, relate to, and/or concern, at least in part, one or more rules, procedures, criteria, characteristics, policies, and/or instructions that (1) may be intended to and/or may be used to control, affect, and/or manage, at least in pall, cache memory, (2) when implemented, at least in part, may affect cache memory and/or allocate, at least in part, cache memory bandwidth, and/or (3) when implemented, at least in part, may result in one or more changes to the operation of cache memory and/or in one or more changes to cache memory bandwidth. In this embodiment, a cache hit may indicate that data requested to be retrieved from a cache memory is presently stored, at least in part, in the cache memory. In this embodiment, a cache miss may indicate that data requested to be retrieved from a cache memory is not presently stored, at least in part, in the cache memory.

By way of example, in operation, after respective information 160N has been stored, at least in part, in cache 150, additional network traffic (e.g., to be included in traffic NT1) may be classified in classification C1 with the highest priority P1. As a result, one or more additional buffer addresses may be allocated to one or more buffers 130A to receive, at least in part, such additional traffic, and/or translation agent circuitry 119 may provide to adapter 121 one or more additional cache entries and/or additional respective IOAT information to be included in entries 162A and/or information 164A, respectively. The particular policies POLICY A, N in one or more policies 120 may be dynamically adjusted (e.g., by circuitry 119 and/or chipset 14) in order to implement, at least in part, particular bandwidth allocations BW1 and BWN in these respective policies POLICY A, N associated with the respective traffic NT1, NTN that may reflect, at least in part, these changes in network traffic classification, and may implement and/or maintain the relative priorities associated with such traffic. For example, in order to implement these adjustments to respective POLICY A, N and/or bandwidth allocations BW1 and/or BWN, adapter 121 may evict, at least in part, at least one portion of information 160N from cache 150, and may fill one or more additional cache entries and/or additional respective IOAT information into cache 150 (e.g., in entries 162A and/or information 164A, respectively).

Alternatively or additionally, by way of example, the respective bandwidth allocations BW1 and/or BWN may be dynamically adjusted, at least in part, as a result of and/or via preferences PREF A and/or PREF N (and/or other preferences and/or modifications) to be dynamically applied to one or more policies POLICY A, N. These preferences may be dynamically selected, at least in part, via (e.g., real-time or near real-time) user input supplied using the not shown user interface system of node 10, and/or via one or more user and/or other applications 39. The adjustments made to the allocations BW1 and/or BWN may result, at least in pail, in the eviction, at least in part, of information 160N from cache 150 in favor of the filling of the one or more additional cache entries and/or additional respective IOAT information (e.g., in entries 162A and/or information 164A, respectively) in cache 150.

Further alternatively or additionally, these respective bandwidth allocations BW1 and/or BWN may be dynamically adjusted, at least in part, as a result of and/or via congestion notifications provided to adapter 121 and/or network congestion conditions (e.g., conditions A, N). For example, network congestion conditions A, N may indicate one or more real time or near real time network congestion conditions associated with network traffic NT1 and/or NTN that, if detected, may trigger modification to bandwidth allocations BW1 and/or BWN, and/or the modifications to be applied to such allocations BW1 and/or BWN in event of such conditions. If adapter 121 and/or node 10 receive notification (e.g., via one more network congestion notification messages) that one or more such network congestion conditions exist, adapter 121 may dynamically adjust bandwidth allocations BW1 and/or BWN to make such specified modifications that may reflect, at least in part, these changes in network traffic classification, and may implement and/or maintain the relative priorities associated with such traffic despite the network congestion. These modifications to the allocations BW1 and/or BWN may result, at least in part, in the eviction, at least in part, of information 160N from cache 150 in favor of the filling of the one or more additional cache entries and/or additional respective IOAT information (e.g., in entries 162A and/or information 164A, respectively) in cache 150.

In this embodiment, as a result, at least in part, of one or more policies 120, contents/parameters thereof (e.g., POLICY A . . . N, bandwidth allocations BW1 BWN, congestion conditions A . . . N, and/or one or more preferences PREF A . . . N), and/or dynamic adjustments thereto (e.g., based at least in part upon real-time or near real time network conditions and/or user/application input), a relatively lower cache miss probability may result in connection with one or more information subsets 160A compared to a relatively higher cache miss probability that may result in connection with one or more information subsets 160N. These features of this embodiment also may allocate a relatively larger amount of cache bandwidth to respective information 160A than to respective information 160N (e.g., BW1 may be greater than BWN). Additionally, these features of this embodiment also may result, at least in part, in a relatively higher cache eviction probability for respective information 160N compared to a relatively lower cache eviction probability for respective information 160A. These relative differences in cache hit/cache miss and/or cache eviction probabilities in connection with various types, priorities, and/or classifications of network traffic NT1 . . . NTN may be empirically selected to achieve, reflect, implement, and/or result in, at least in part, the respective priorities P1 . . . PN associated with the respective traffic NT1 . . . NTN, despite dynamic changes in network conditions, user/application preferences, etc. This may result, for example, from appropriate reduction in latencies in processing higher priority traffic compared to lower priority traffic.

Without departing from this embodiment, PCI-SIG address translation services may not be employed. In this case, other types of messages (e.g., PCI Express messages routed to root port to advise that an I/O memory management unit update/evict appropriate cache entries, and/or direct attached protocol messages) may be employed in connection with adapter 121. The PCI Express messages may comply and/or be compatible with PCI Express Base Specification 2.0, 2007, published by PCI-SIG (and/or other and/or later versions of thereof). Also, the teachings of this embodiment may be advantageously employed to process network traffic to be transmitted from node 10 in addition to and/or instead of received traffic NT1 . . . NTN. Also without departing from this embodiment, one or more policies 120 may statically assign bandwidth BW1 . . . BWN.

Thus, an embodiment may include circuitry to facilitate implementation, at least in part, of at least one cache management policy. The at least one policy may be based, at least in part, upon respective priorities of respective classifications of respective network traffic. The at least one policy may concern, at least in part, caching of respective information associated, at least in part, with the respective network traffic belonging to the respective classifications.

Many other and/or additional modifications, variations, and/or alternatives are possible without departing from this embodiment. Accordingly, this embodiment should be viewed broadly as encompassing all such alternatives, modifications, and variations.

What is claimed is:

1. An apparatus comprising:
circuitry to facilitate implementation, at least in part, of at least one cache management policy, the at least one policy-being based, at least in part, upon respective priorities of respective classifications of respective network traffic, the at least one policy concerning, at least in part, caching of respective information associated, at least in part, with the respective network traffic belonging to the respective classifications.

2. The apparatus of claim 1, wherein:
the respective information comprises respective input/output (I/O) address translation information associated, at least in part, with respective buffers associated, at least in part, with the respective network traffic;
the respective priorities result, at least in part, in establishment of relative priorities between the respective traffic; and
the respective classifications are based at least in part upon one or more of:
respective traffic flows of the respective network traffic;
respective protocols employed in the respective network traffic; and
respective types of the respective network traffic.

3. The apparatus of claim 1, wherein:
the at least one policy implements, at least in part, one or more of the following:
respective amounts of cache bandwidth to be allocated to the respective information;
respective policies for filling and evicting respective cache entries associated with the respective information; and
one or more preferences selected, at least in part, by at least one of:
user input and one or more applications.

4. The apparatus of claim 3, wherein:
the respective policies are based at least in part upon at least one of:
network congestion; and
the respective amounts of cache bandwidth to be allocated to the respective information.

5. The apparatus of claim 1, wherein:
the respective priorities include at least one relatively higher priority and at least one relatively lower priority;
certain network traffic is associated with the at least one relatively higher priority;
other network traffic is associated with the at least one relatively lower priority;
the respective information comprises a first subset and a second subset, the first subset being associated with the certain network traffic, the second subset being associated with the other network traffic; and
the at least one policy results, at least in part, in a relatively lower cache miss probability in connection with the first subset compared to a relatively higher cache miss probability in connection with the second subset.

6. The apparatus of claim 1, wherein:
the at least one policy is to dynamically allocate to and fill respective amounts of cache bandwidth with the respective information based at least in part upon (1) respective relative priorities of the respective network traffic associated with the respective information and (2) changes in the respective network traffic; and
the at least one policy results, at least in part, in a relatively higher cache eviction probability for the respective information associated with relatively lower priority network traffic compared to a relatively lower cache eviction probability for the respective information associated with relatively higher priority network traffic.

7. The apparatus of claim 6, wherein:
the at least one policy is to allocate a relatively larger amount of the cache bandwidth to the respective information associated with the relatively higher priority network traffic compared to a relatively smaller amount of the cache bandwidth to be allocated to the respective information associated with the relatively lower priority network traffic.

8. The apparatus of claim 1, wherein:
the circuitry is to execute, at least in part, at least one program that implements, at least in part, the at least one policy; and
the apparatus comprises a network adapter that comprises cache memory to cache at least one portion of the respective information.

9. A method comprising:
facilitating implementation, at least in part, by circuitry, of at least one cache management policy, the at least one policy being based, at least in part, upon respective priorities of respective classifications of respective network traffic, the at least one policy concerning, at least in part, caching of respective information associated, at least in part, with the respective network traffic belonging to the respective classifications.

10. The method of claim 9, wherein:
the respective information comprises respective input/output (I/O) address translation information associated, at least in part, with respective buffers associated, at least in part, with the respective network traffic;
the respective priorities result, at least in part, in establishment of relative priorities between the respective traffic; and
the respective classifications are based at least in part upon one or more of:
respective traffic flows of the respective network traffic;
respective protocols employed in the respective network traffic; and
respective types of the respective network traffic.

11. The method of claim 9, wherein:
the at least one policy implements, at least in part, one or more of the following:
respective amounts of cache bandwidth to be allocated to the respective information;
respective policies for filling and evicting respective cache entries associated with the respective information; and
one or more preferences selected, at least in part, by at least one of: user input and one or more applications.

12. The method of claim 11, wherein:
the respective policies are based at least in part upon at least one of:
network congestion; and
the respective amounts of cache bandwidth to be allocated to the respective information.

13. The method of claim 9, wherein:
the respective priorities include at least one relatively higher priority and at least one relatively lower priority;
certain network traffic is associated with the at least one relatively higher priority;
other network traffic is associated with the at least one relatively lower priority;
the respective information comprises a first subset and a second subset, the first subset being associated with the certain network traffic, the second subset being associated with the other network traffic; and
the at least one policy results, at least in part, in a relatively lower cache miss probability in connection with the first subset compared to a relatively higher cache miss probability in connection with the second subset.

14. The method of claim 9, wherein:
the at least one policy is to dynamically allocate to and fill respective amounts of cache bandwidth with the respective information based at least in part upon (1) respective relative priorities of the respective network traffic associated with the respective information and (2) changes in the respective network traffic; and
the at least one policy results, at least in part, in a relatively higher cache eviction probability for the respective information associated with relatively lower priority network traffic compared to a relatively lower cache eviction probability for the respective information associated with relatively higher priority network traffic.

15. The method of claim 14, wherein:
the at least one policy is to allocate a relatively larger amount of the cache bandwidth to the respective information associated with the relatively higher priority network traffic compared to a relatively smaller amount of the cache bandwidth to be allocated to the respective information associated with the relatively lower priority network traffic.

16. The method of claim 9, wherein:
the circuitry is to execute, at least in part, at least one program that implements, at least in part, the at least one policy; and
a network adapter comprises cache memory to cache at least one portion of the respective information.

17. Computer-readable memory storing one or more instructions that when executed by a machine result in performance of operations comprising:
facilitating implementation, at least in part, by circuitry, of at least one cache management policy, the at least one policy being based, at least in part, upon respective priorities of respective classifications of respective network traffic, the at least one policy concerning, at least in part, caching of respective information associated, at least in part, with the respective network traffic belonging to the respective classifications.

18. The computer-readable memory of claim 17, wherein:
the respective information comprises respective input/output (I/O) address translation information associated, at least in part, with respective buffers associated, at least in part, with the respective network traffic;
the respective priorities result, at least in part, in establishment of relative priorities between the respective traffic; and
the respective classifications are based at least in part upon one or more of:
respective traffic flows of the respective network traffic;
respective protocols employed in the respective network traffic; and
respective types of the respective network traffic.

19. The computer-readable memory of claim 17, wherein:
the at least one policy implements, at least in part, one or more of the following:
respective amounts of cache bandwidth to be allocated to the respective information;
respective policies for filling and evicting respective cache entries associated with the respective information; and
one or more preferences selected, at least in part, by at least one of: user input and one or more applications.

20. The computer-readable memory of claim 19, wherein:
the respective policies are based at least in part upon at least one of:
network congestion; and
the respective amounts of cache bandwidth to be allocated to the respective information.

21. The computer-readable memory of claim 17, wherein:
the respective priorities include at least one relatively higher priority and at least one relatively lower priority;
certain network traffic is associated with the at least one relatively higher priority;
other network traffic is associated with the at least one relatively lower priority;
the respective information comprises a first subset and a second subset, the first subset being associated with the certain network traffic, the second subset being associated with the other network traffic; and
the at least one policy results, at least in part, in a relatively lower cache miss probability in connection with the first subset compared to a relatively higher cache miss probability in connection with the second subset.

22. The computer-readable memory of claim 17, wherein:
the at least one policy is to dynamically allocate to and fill respective amounts of cache bandwidth with the respective information based at least in part upon (1) respective relative priorities of the respective network traffic associated with the respective information and (2) changes in the respective network traffic; and
the at least one policy results, at least in part, in a relatively higher cache eviction probability for the respective information associated with relatively lower priority network traffic compared to a relatively lower cache eviction probability for the respective information associated with relatively higher priority network traffic.

23. The computer-readable memory of claim 22, wherein:
the at least one policy is to allocate a relatively larger amount of the cache bandwidth to the respective information associated with the relatively higher priority network traffic compared to a relatively smaller amount of the cache bandwidth to be allocated to the respective information associated with the relatively lower priority network traffic.

24. The computer-readable memory of claim 17, wherein:
the circuitry is to execute, at least in part, at least one program that implements, at least in part, the at least one policy; and
a network adapter comprises cache memory to cache at least one portion of the respective information.
